(19) United States
(12) Patent Application Publication
(10) Pub. No.: US 2019/0137751 A1
(43) Pub. Date: May 9, 2019

(54) MICROSCOPE COMPRISING GROUPS OF LIGHT EMITTERS FOR ILLUMINATION, AND MICROSCOPY METHOD

(71) Applicant: Carl Zeiss Microscopy GmbH, Jena (DE)

(72) Inventors: Ingo KLEPPE, Jena (DE); Thomas KALKBRENNER, Jena (DE)

(21) Appl. No.: 16/093,823

(22) PCT Filed: Apr. 12, 2017
(86) PCT No.: PCT/EP2017/058778

§ 371 Date: Oct. 15, 2018

(30) Foreign Application Priority Data
Apr. 15, 2016 (DE) 10 2016 107 041.6

(51) Int. Cl. G02B 21/36; G02B 21/06; G02B 21/16; G02B 27/48

(52) U.S. Cl. CPC G02B 21/367; G02B 27/48; G02B 21/16; G02B 21/06

(57) ABSTRACT

A microscope and method for imaging an object in an object field, the microscope having an illumination device for wide-field illumination of the object. The illumination device has a plurality of light sources, a detection device for recording a wide-field image of the object, and a control device for controlling the detection device and the illumination device. The control device divides the light sources into at least two groups. The light sources of all groups combined fill the object field entirely. The control device for each group switches on all light sources of the group, causes the detection device to record a single image of the object, switches off the light sources of the group, and thus interconnects all groups, and generates a plurality of single images. From the generated single images, an image of the object is generated by the control device.

### RELATED APPLICATIONS

The present application is a U.S. National Stage application of International PCT Application No. PCT/EP2017/058778 filed on Apr. 12, 2017 which claims priority benefit of German Application No. DE 10 2016 107 041.6 filed on Apr. 15, 2016, the contents of each are incorporated by reference in their entirety.

### FIELD OF THE INVENTION

The invention relates to a microscope for imaging an object in an object field, wherein the microscope has an illumination device for wide-field illumination of the object. The illumination device has a plurality of light sources, a detection device for recording a wide-field image of the object and a control device for controlling the detection device and the illumination device. The invention further relates to a microscopy method for imaging an object in an object field, which is illuminated in wide field using an illumination device having a plurality of light sources.

### BACKGROUND OF THE INVENTION

In classical light microscopy, when examining three-dimensionally extended objects, i.e. objects having an extent that is greater along the optical axis than the depth of field of the lenses used, the problem arises that the sharp image is superimposed with extra-focal image components which are imaged unsharp. These prevent confocal imaging, in which a pinhole is used to block out light coming from above and below the focal plane, which therefore does not contribute to the image. In this way, what is known as an optical section is produced. By recording a plurality of optical section images in different focal positions, a “z stack” can be obtained, which makes possible three-dimensional representation of the object.

Another way of producing optical sections is the use of structured illumination. Reference is made by way of example to EP 1556728 B1. The depth discrimination is here improved by an object being illuminated with a periodic structure, a registration of the thus produced brightness distribution being effected, the phase position of the periodic structure being shifted and the registered brightness distributions being offset against one another in a calculation in order to obtain an object brightness distribution. This procedure utilizes the principle that the object is illuminated differently and a depth discrimination is able to be calculated due to the different illumination.

Moreover, it is also possible to obtain a depth discrimination by way of an image being produced with homogeneous illumination and an image being produced with a random intensity distribution, as is described, for example, in Daryl Lim et al., “Wide-field fluorescence sectioning with hybrid speckle and uniform-illumination microscopy,” Aug. 15, 2008, Vol. 33, No. 16, Optical Letters.

For other methods with the same effect, reference is made to L. H. Schafer et al., “Structured illumination microscopy: artefact analysis and reduction utilizing a parameter optimization approach,” Vol. 216, Pt 2, November 2004, pages 165 to 174, Journal of Microscopy, and G. Danuser and C. Waterman-Storer, “Quantitative fluorescent speckle microscopy of cytoskeleton dynamics,” Annu. Rev. Biophys, Biomol., Struct., 2006, 35:361-87.

### OBJECTS OF THE INVENTION

It is an object of the invention to provide a microscope and a microscopy method that can be used to obtain improved depth discrimination.

### SUMMARY OF THE INVENTION

The invention is defined in the annexed independent claims. The dependent claims are directed to preferred exemplary embodiments of the invention.

The invention provides a microscope for imaging an object in an object field, wherein the microscope has an illumination device, a detection device or a control device. The illumination device serves for producing wide-field illumination of the object and has a plurality of light sources. The detection device is provided for recording a wide-field image of the object. The controller controls the detection device and the illumination device. The control device divides the light sources into at least two groups, wherein the light sources of all groups together fill the object field without gaps. For each group, the control device switches on all light sources of a group, prompts the detection device to record an individual image of the object, and switches off the light sources of this group. The control device produces an image of the object from the individual images produced, in particular taking into account the position of the individual light sources for the corresponding individual image.

Illumination and imaging take place in wide field, i.e. not confocally. The object field that is consequently defined by the imaging on or in the object is covered by the groups without gaps, i.e. completely. The groups are individually switchable and the light sources are variably allocable to the groups depending on the operating mode. In embodiments, the light sources of the groups are embodied as individual light emitters, e.g. as light emitters arranged in a plane, in particular LEDs, which can be switched on and off individually. The object is consequently illuminated with different illumination patterns, and an individual image of the object is recorded for each illumination pattern.

The plurality of the light sources makes it possible to illuminate the object variably, i.e. with different illumination patterns, for depth discrimination. In embodiments, the control device performs the allocation of the light sources to individual groups in dependence on the operating mode, e.g. in dependence on a previously provided setting signal that requests a specific operating mode.

In embodiments, the illumination of the object is furthermore adapted with respect to the optical properties of the object. A further advantage of the microscope is the fact that no parts of the microscope need to be mechanically moved to produce the variable illumination for the individual images. For example, no provision is made for moving a grating or a diffusor in the illumination beam path. Insertion of a diffusor for producing a quasi-stochastic intensity distribution is dispensed with. Since no mechanical parts need to be moved, the measurement duration is reduced. The switching time of the light sources is shorter than the duration for moving mechanical parts.

The control device divides the light sources into different groups, wherein the light sources of all groups together illuminate the object within a given region, i.e. in the object field, completely, that is to say without gaps. That means that the light sources of all groups, when projected into the object field, are directly adjacent to one another. There are no gaps in the illumination of the object. It is thus possible to illuminate the object with a regular intensity distribution, in particular homogeneously. The regular intensity distribution of the illumination is present when the light sources of all groups are switched on and/or when the light sources of one group are switched on. The illumination of the object is regular when the intensity distribution that has been projected into the object field is the same for each light source and the switched-on light sources have a regular distribution upon observation that is projected into the object field. For particularly good homogeneity, the intensity distributions of the individual light sources projected into the object field overlap in embodiments. Optional homogeneous illumination of the object in embodiments is achieved by projecting the light sources into the object field such that the intensity distributions of the overlap regions of the individual light sources add up such that the sum of the radiation intensity at each point of the object is constant or nearly constant. For example, the variation in radiation intensity over the object is less than 5%, 10% or 20%.

The light sources can be divided into the individual groups automatically or manually, depending in particular on the properties of the object. In embodiments, the light sources are divided into the groups such that bleaching of fluorescent dyes in the object is prevented. This is accomplished, for example, by a specific location of the object being illuminated only once when the light sources of two groups are switched on one after the other. Possible ways of dividing into groups will be explained in more detail below.

The illumination device in embodiments comprises a screen or a display, wherein pixels of the illumination device are the light sources. In a different embodiment, the illumination device includes an array of light-emitting diodes (LED) or other point-type light sources. The individual light sources optionally have an identical design.

The control device is connected to the individual light sources, for example via electric lines, with the result that it hereby switches the respective light sources on or off individually and in this way also divides them into the groups in dependence on the operating mode.

The control device switches on all light sources of a first group, prompts the detection device to produce an individual image, and then switches off all light sources of the first group. This procedure is repeated for all groups, with the result that for each group an individual image is produced, the illumination of which differs from that of the other individual images. The control device produces from the individual images a full image of the object having an improved depth of field. When calculating the full image, the location of the individual light sources in the respectively switched-on group is optionally taken into account.

In a preferred embodiment, the individual images are calculated to form the full image in a modular, retrofittable, e.g. mobile, system directly on a camera of the detection device, for example by way of a field programmable gate array (FPGA). In embodiments, the detection device furthermore acts as a trigger for the actuation of the light sources. In this way, fast output of the full image with increased depth discrimination can be achieved.

In order to simulate known methods in which for depth discrimination a grating is moved through the illumination beam path, and in order to be able to use the calculation methods for depth discrimination thereof, the control device in embodiments assigns the light sources to groups such that the light sources provide an illumination of the object that corresponds to a homogeneous illumination with a downstream grating. Herefor, provision is made for the light sources of at least one of the groups, in particular of all groups, to be directly adjacent to one another in the object field. In this way it is possible to produce an illumination pattern in the object field that is, for example, grid-shaped or stripe-shaped. If the light sources of each group are directly adjacent to one another, no gaps in the intensity distribution will appear in the illuminated region in the illumination pattern of the individual groups. The light sources of the other groups in the object field preferably are directly adjacent to one another, such that the light sources of the different groups in the object field complement one another to obtain illumination with a regular intensity distribution. In embodiments, the light sources of a first group and of a second group are arranged in each case in stripe-shaped fashion, with the stripes complementing one another to form a total field. Preferably, a plurality of alternating stripes are formed by the two groups. Each light source is allocated to exactly one group, such that the groups form sets of light sources which are pairwise disjoint.

One advantage of using a plurality of light sources to produce a grid-shaped or stripe-shaped illumination pattern is that the grid spacings or the stripe spacings can be easily adapted to the conditions prevailing in the object by way of a variable allocation of the light sources to the groups. In this way it is possible to realize illumination patterns with different grid constants or stripe spacings, which would not be possible in the case of any mechanical gratings.

Another embodiment makes provision for the illumination to have a quasi-stochastic intensity distribution, as is realized for example in the prior art by speckle patterns. This type of illumination is realized by way of assigning the light sources such that for at least one of the groups, in particular all groups, gaps exist in the object field. This means in particular that with this type of division of the light sources into groups, the illumination pattern does not have regional illumination with a regular intensity distribution, as in the case of, for example, stripe illumination or grid illumination, but that the light sources are assigned to groups irregularly, e.g. randomly. The advantage of this embodiment is that burning (bleaching) of the specimen and associated artefacts are avoided as compared to the prior art. The control device in particular assigns the light sources such that all light sources together realize illumination of the object with a regular intensity distribution, in particular a homogeneous illumination, with the result that the number of the individual images to be produced is reduced as compared to an illumination using laser speckles, since in the case of the speckle illumination an intensity distribution would not be settable at a predetermined location during the illumination of the object. Consequently, it is possible with the lowest possible number of illumination cycles to completely and regularly illuminate the region of the object to be investigated, wherein the contrast can be maximized due to the division of the light sources into the individual groups. In a normal speckle light source, it would not be possible to control the intensity distribution.

Known from the prior art is an increase in depth discrimination by way of producing an individual image with a gapless illumination and subsequently producing an individual image with speckle illumination. This variant for producing a full image having increased depth discrimination is realized in embodiments by way of the light sources of a first group in the object field being directly adjacent to one another and the light sources of a second group forming a subset of the light sources of the first group. The light sources of the first group in this embodiment are preferably directly adjacent to one another, with the result that a regular, in particular homogeneous, illumination of the object is realized. The light sources of the first group for example form on the detection device a rectangle or a circle, which are filled without gaps by the light sources of the first group. To produce speckle illumination, light sources are selected randomly or quasi-stochastically from the light sources of the first group and allocated to the second group. The selection of the light sources for the second group can in this case also be optimized with respect to the specimen.

In many cases, it is desired for the object to be imaged in a plurality of colors or wavelength ranges. To this end, it is preferred if the light sources are in each case configured to produce radiation in at least two different wavelength ranges, wherein the control device actuates the light sources to emit radiation having different wavelength ranges, wherein the control device preferably provides a set of groups for each wavelength range, and wherein furthermore the light sources of one set preferably fill the object field without gaps and the sets of groups differ. The light sources can be embodied, for example, to produce radiation directly in at least two selectable different wavelength ranges. Alternatively, it is possible to provide for each wavelength range an array of light sources, the radiation of which is combined using a beam-combining device, with the result that the intensity distribution that is projected into the object field for each pair (in the case of more than two wavelength ranges: n-tuples) of associated light sources is identical and situated at the same location in the object field. The control device actuates the light sources and divides them into groups in dependence on wavelength. For each wavelength range, one set of groups is provided, wherein the above-mentioned considerations apply to each set of groups. The light sources of one set of groups optionally illuminate the object field without gaps, with the result that, when the light sources of a set of groups are switched on together, the object field is illuminated with a regular intensity distribution. If the light sources for a wavelength range are divided into groups, the divisions of the light sources of the respective wavelength ranges differ. Consequently, the individual light sources are variably divided into groups depending on the wavelength range of the illumination, with the result that the groups for the different wavelength ranges differ. For example, one and the same light source is assigned to different groups, depending on the wavelength range in which it is to emit light. A preferred advantage of this embodiment is the ability to produce at the same time individual images with different wavelength ranges of the illumination, wherein, depending on the wavelength range, a dedicated illumination pattern can be used, with the result that crosstalk between the wavelength ranges can be minimized. In particular, the groups for the different wavelength ranges are assigned such that light sources do not simultaneously emit radiation with the different wavelength ranges, but only radiation of one wavelength range. The light sources are preferably divided into groups such that light sources that simultaneously emit light of different wavelength ranges are spaced apart from one another in the object field such that crosstalk can be prevented. In particular, the groups for all wavelength ranges form sets of light sources which are pairwise disjoint. Moreover, as compared to the prior art, the illumination pattern can be adapted individually depending on the wavelength range, and in this way greater variability can be attained.

If the intention is to produce a full image of the object that displays the largest possible region of the object, it is preferred that all available light sources are used. In this way it is possible to obtain an object field of maximum size. Alternatively, it is possible for the illumination to be concentrated on regions of interest in the object field, for example on sections of the object in which a predetermined structure is located. To this end, it is preferred for the control device to select a few light sources from all available light sources and to divide them into the groups. The remaining light sources permanently remain dark. For this purpose, preferably a preliminary image is first recorded, in which all light sources are switched on, and subsequently light sources are selected and divided into groups that illuminate a partial region of the object. This partial region corresponds to a region of interest that is selectable by the user.

To simplify the illumination device, provision may be made for the light sources to be arranged or configured in the form of columns, wherein the light sources are able to be switched on and off only in columns. This embodiment produces a stripe-shaped illumination pattern or a grid-shaped illumination pattern. The construction of the illumination device can be simplified in this way. The columns can also be considered to be rows.

The invention provides a microscopy method for imaging an object in an object field, having the following steps:
a) illuminating the object in wide field using an illumination device having a plurality of light sources,
b) dividing the light sources into at least two groups, wherein the light sources of all groups together fill the object field without gaps,
c) switching on all light sources of a group, producing an individual image of the object for this group in wide field, and switching off the light sources of this group,
d) repeating step c) for each group, and
e) producing an image of the object field from the individual images, in particular taking account of the location of the individual light sources for the corresponding individual image.

The microscopy method can be performed in particular on the above-described microscope. The advantages described in connection with the microscope, preferred embodiments and variants analogously apply to the microscopy method.

It is preferred for the light sources of at least one of the groups to illuminate the object field in the form of a grid or at least one stripe.

It is furthermore preferred for the light sources of at least one of the groups to illuminate the object field quasi-stochastically.

It is also preferred for the light sources of a first group to be selected such that the light sources thereof homogeneously illuminate the object and for the light sources of a second group to be selected quasi-stochastically from the light sources of the first group.

It is preferred for radiation with at least two different wavelength ranges to be produced per light source, wherein a set of groups is provided for each wavelength range, wherein the light sources of a set fill the object field without gaps and the sets of groups differ.

It is furthermore preferred for the light sources of all groups to correspond to the total number of light sources.

It is preferred that first, a preliminary image is recorded in which all light sources are switched on, and subsequently the light sources are divided into groups such that the light sources of all groups illuminate only a partial region of the object.

It goes without saying that the aforementioned features and those yet to be explained below can be used not only in the combinations specified but also in other combinations or on their own, without departing from the scope of the present invention.

### BRIEF DESCRIPTION OF THE DRAWINGS

The invention is explained in more detail below for example on the basis of the accompanying drawings, which also disclose features essential to the invention. In the figures:

FIG. 1 schematically illustrates the construction of a microscope;

FIGS. 2a, 2b and 2c schematically illustrate embodiments of an illumination device of the microscope shown in FIG. 1; and

FIGS. 3a, 3b, 3c, 3d, 3e, 3f and 3g show possibilities of dividing the light sources of the illumination device of the microscope of FIGS. 1 and 2 into groups.

### DETAILED DESCRIPTION OF EMBODIMENTS OF THE INVENTION

A microscope 10 has an illumination device 12, a detection device 14 and a control device 16. The microscope 10 is configured to produce an image of an object 18 in wide field. To this end, the illumination device 12 produces illumination radiation 20 in wide field, with which the object 18 is illuminated. The illumination radiation 20 passes through a beam splitter 22, a zoom optical unit 24, and a lens 26. The zoom optical unit 24 is tasked with imaging the illumination device 12 onto the object 18 with different magnification scales. The lens 26 is used for focusing the illumination radiation 20 onto the object 18.

Present in the object 18 are fluorescent dyes, which are excited by the illumination radiation 20 to emit emission light. The light that is emitted or reflected by the object 18 is collected by the lens 26 and guided from the zoom optical unit 24 to the beam splitter 22 in the form of imaging radiation 28. The beam splitter 22 is configured as a dichroic mirror, transmitting the illumination radiation 22 and reflecting the imaging radiation 28 on account of the different wavelength ranges of the emission and the absorption spectrum of the fluorescent dye present in the object 18. The beam splitter 22 directs the imaging radiation 28 to an emission filter 30, which is configured to block radiation in the spectral range of the illumination radiation 20 and to transmit radiation in the wavelength range of the emission spectrum of the fluorescent dyes. The imaging radiation 28 travels from the emission filter 30 onto the detection device 14. The detection device 14 comprises an imaging optical unit 32 and a sensor 34. The imaging optical unit 32 focuses the imaging radiation 28 onto the sensor 34. The sensor 34 converts the imaging radiation 28 into electrical signals, which are passed on to the control device 16. To this end, the control device 16 is connected in data-technological terms by an electric line to the detection device 14. The control device 16 produces individual images of the object 18 from the electrical signals and a depth-resolved full image of the object 18 from the individual images.

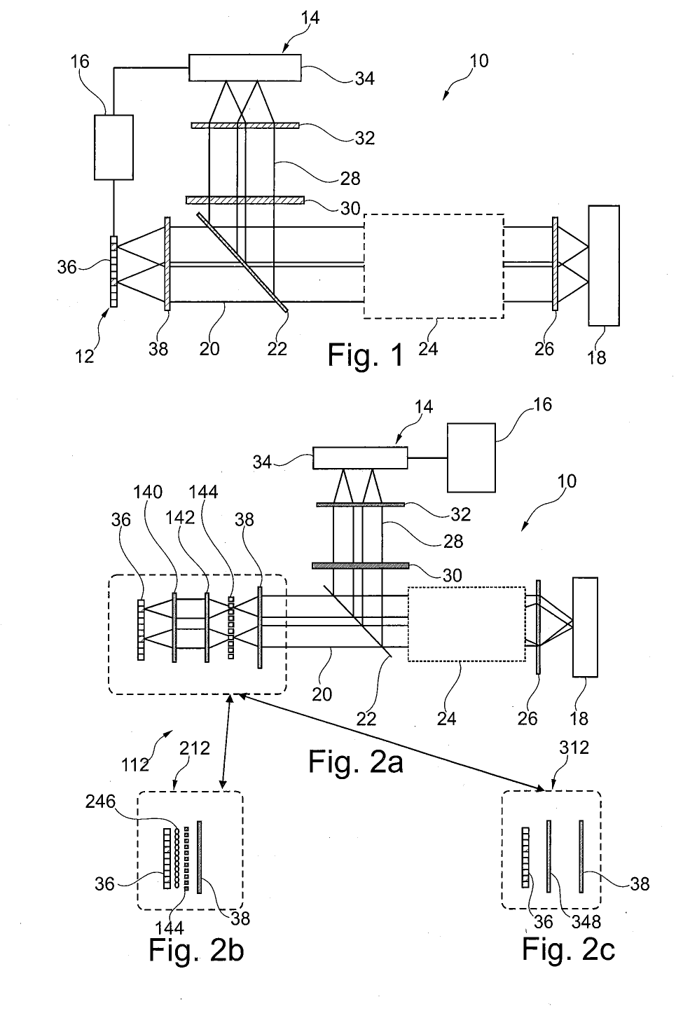

The illumination device 12 in the embodiment shown in FIG. 1 comprises a plurality of light sources 36 and an illumination optical unit 38. The light sources 36 are each configured to emit radiation in different, selectable wavelength ranges. In the embodiment illustrated, they are arranged in an array. The illumination optical unit 38 has a focal length corresponding to the distance between the light sources 36 and the illumination optical unit 38, with the result that the illumination radiation 20 is parallelized after passage through the illumination optical unit 38. The light sources 36 are connected to the control device 16 via an electric line, such that the control device 16 can switch the light sources 36 on and off individually and can control the emission of radiation in the individual wavelength ranges. In this way, any desired illumination patterns can be produced. In a simplified embodiment, the control device 16 can switch the light sources 36 on or off only in columns and/or rows, with the result that only stripe-shaped or grid-shaped illumination patterns are possible.

The light sources 36 are imaged into an object field of the object 18 using the zoom optical unit 24 and the lens 26 such that here an arrangement of the light sources 36 in the form of the array is obtained. Pixels of the sensor 34 are also arranged in an array, which can be viewed projected through the zoom optical unit 24 and the lens 26 into the object field of the object 18. These projections of the light sources 36 and of the pixels of the sensor 34 overlap, such that one pixel of the sensor 34 is allocated to each light source 36. In this way, non-scanning imaging of the object 18 is possible, i.e. object 18 and illumination/imaging are not moved relative to one another, and it is still possible to illuminate and image the object 18 with different illumination states corresponding to a scanning.

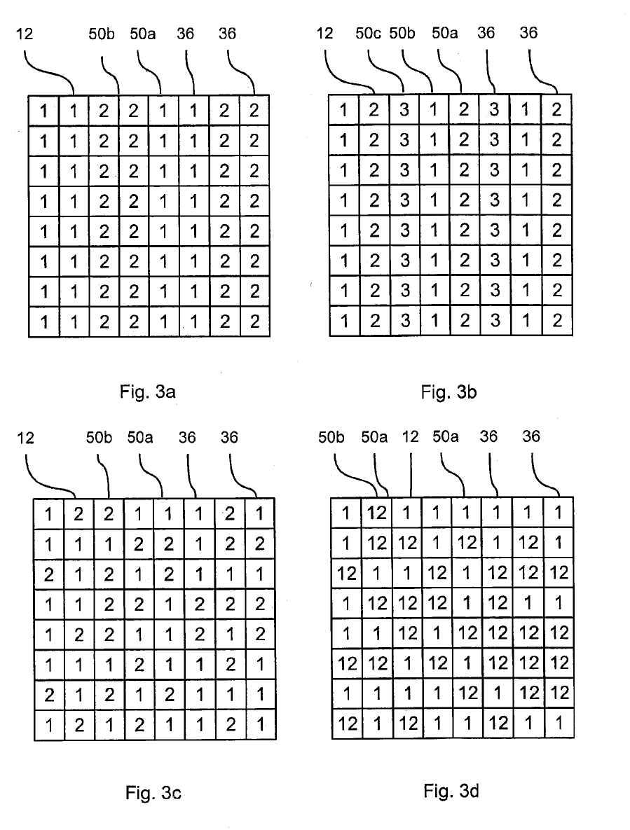

Embodiments of the illumination device 112, 212, 312 will now be discussed in connection with FIGS. 2a to 2c. The construction of the microscope 10 in FIGS. 2a to 2c is identical to the construction in accordance with FIG. 1, except for the illumination device 12. For the sake of clarity, the connection of the light sources 36 to the control device 16 is not shown in FIGS. 2a to 2c. The illumination devices 112, 212, 312 can be used instead of the illumination device 12.

The illumination device 112 in FIG. 2a likewise has a plurality of light sources 36 and in addition a first lens element 140, a second lens element 142, a pinhole array 144 and the illumination optical unit 38. The first lens element 140 and the second lens element 142 are arranged such that they image the light sources 36 in each case in the form of a point on a corresponding opening provided in the pinhole array 144. The illumination optical unit 38 has a focal length corresponding to the distance between the pinhole array 144 and the illumination optical unit 38, with the result that the illumination radiation 20 is again parallelized. The first lens element 140, the second lens element 142 and the pinhole array 144 serve to provide point-shaped illumination sources. In this way, it is possible to use light sources 36 which themselves are not point-shaped but have a certain extent.

The illumination device 212, as shown in FIG. 2b, has a plurality of light sources 36, a microlens array 246, the pinhole array 144 and the illumination optical unit 38. The microlens array 246 comprises a plurality of microlenses, which are arranged in accordance with the light sources 36. The holes of the pinhole array 144 are also arranged in accordance with the light sources 36 and the lens elements of the microlens array 246. The lens elements of the microlens array 246 serve to focus the light sources 36 onto the holes of the pinhole array 144. The focal length of the illumination optical unit 38 is again such that it corresponds to the distance between the pinhole array 144 and the illumination optical unit 38, with the result that the illumination radiation 20 is again parallelized after passage through the illumination optical unit 38. The microlens array 246 in particular performs the same task as the first lens element 140 and the second lens element 142 of the embodiment shown in FIG. 2a of the illumination device 112.

The illumination device 312 comprises a plurality of light sources 36, an optional diffusing plate 348 and the illumination optical unit 38. The diffusing plate 348 diffusely scatters the light coming from the light sources 36, with the result that a particularly homogeneous intensity distribution of the illumination can be achieved in the object field.

The distances between individual light sources 36 and the respective embodiment of the illumination devices 12, 112, 212, 312 are such that the projection of the light sources 36 into the object field produces a regular, at least approximately homogeneous, illumination of the object 18. For example, light sources 36 which have a large extent can be imaged using the first lens element 140 and the second lens element 142 or using the microlens array 246 onto the pinhole array 144 such that the imaging of the pinhole array 144 into the object field results in strongly overlapping illumination cones of the individual light sources 36. An at least approximately homogeneous illumination of the object 18 is thus achieved.

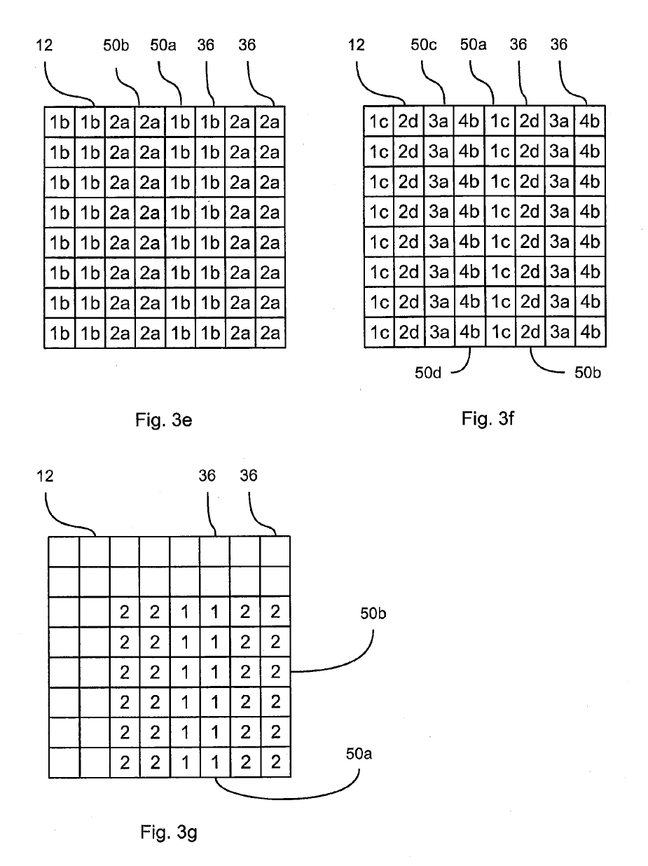

The control device 16 divides the light sources 36 into groups that differ depending on the operating mode, as is illustrated by way of example in FIGS. 3a to 3g. For example, as is shown in FIG. 3a, the control device 16 divides the light sources 36 into two groups 50a, 50b, wherein the light sources 36 that belong to the first group 50a are denoted with “1” and the light sources 36 that belong to the second group 50b are denoted with “2.” The light sources 36 of each group 50a, 50b are arranged such that light sources 36 within one group are located directly adjacently to one another, i.e. adjoin one another. By imaging the light sources 36 into the object field, adjacent light sources 36 also directly adjoin one another in the object field, with the result that light sources 36 of one group produce a regular, in particular homogeneous, illumination of sections of the object field. FIG. 3a, for example, provides stripe-shaped illumination of the object 18 for each individual image.

The control device 16 first switches on all light sources 36 that currently belong to the first group 50a and prompts the detection device 14 to produce an individual image of the object 18. Next, the light sources 36 of the first group 50a are switched off and the light sources 36 of the current second group 50b are switched on, and the control device 16 prompts the detection device 14 to record a further individual image of the object 18. The control device 16 now offsets the individual images against one another in a calculation in order to produce a full image of the object 18 with enhanced depth discrimination. The location of the light sources 36 which are switched on for each individual image can here be used for the calculation. In an alternative embodiment, the image is calculated without taking into account which of the light sources 36 were switched on for the respective individual image. This is accomplished for example with the following equation:

$${I}_{f} = {\sum }_{i = 1}^{N} {I}_{i} - \sqrt[N]{{\prod }_{i = 1}^{N} {I}_{i}}$$

I_{f} indicates the full image, Iᵢ indicates the individual images and N indicates the number of the individual images; in the example of FIG. 2a, N equals two. The individual images Iᵢ are added up, which produces a typical wide-field image without optical section. The individual images Iᵢ are then multiplied with one another, which corresponds to a logical “AND.” The result is normalized, for example with the N-th root. In this way, the weakly modulated components are ascertained, which corresponds to the extra-focal component of the radiation that is not modulated or only weakly modulated with the illumination. The subtraction of this image information from the above-described total sum results in an optical section, such that the full image I_{f} has a better depth discrimination.

A further possible division of the light sources 36 into groups is shown in FIG. 3b. Here, the light sources 36 are divided into three groups 50a, 50b, 50c, wherein each group provides a stripe-shaped illumination of the object 18. Once again, light sources 36 within one group here are arranged such that they directly adjoin one another, with the result that a homogeneous illumination in the object field is provided. The light sources 36 that belong to the first group 50a are denoted with “1,” the light sources 36 that belong to the second group 50b are denoted with “2” and the light sources 36 that belong to the third group 50c are denoted with “3.” By way of the division of the light sources 36 into the groups as shown in FIGS. 3a and 3b, an illumination of the object 18 is obtained that corresponds to the situation in which the object 18 is illuminated from an illumination through which a stripe-shaped grid is drawn.

A further variant of the division of the light sources 36 into groups is shown by way of example in FIG. 3c. Here, the light sources 36 are statistically distributed over two groups 50a, 50b, wherein the light sources 36 that belong to the first group 50a are again denoted with “1” and the light sources 36 that belong to the second group 50b are denoted with “2.” The object 18 is thus illuminated quasi-stochastically. With this variant, a speckle illumination, as is known in the prior art, can be imitated, wherein the object 18 is also illuminated homogeneously when all light sources 36 of the two groups are switched on. This would not be realizable using a conventional speckle illumination.

A further type of division of the light sources 36 into groups is shown in FIG. 3d. Here, all light sources 36 are allocated to the first group 50a, and the second group 50b comprises light sources 36 which are selected randomly from the light sources 36 of the first group 50a. Those light sources 36 that are allocated both to the first group 50a and to the second group 50b are denoted with “12,” while those which are allocated only to the first group 50 are denoted with “1.” In this embodiment, it is possible to imitate an illumination from the prior art in which the object 18 is first illuminated homogeneously and subsequently with a speckle illumination.

FIG. 3e shows a division into groups, in which the light sources 36 are configured to produce radiation in different wavelength ranges. If the light sources 36 emit light with the first wavelength range, they are denoted with “1” and “2”, in the second wavelength range with “a” and “b.” For each wavelength range, the light sources 36 are divided into groups respectively; in the embodiment shown in FIG. 3e in each case into two groups 50a, 50b. In this embodiment, the light sources 36 are divided such that the light sources 36 simultaneously emit, in the shape of stripes, either radiation in the first wavelength range (1) or radiation in the second wavelength range (a) and then an individual image is recorded. In the next step, the wavelength range of the individual light sources 36 is swapped and once again an individual image is recorded. In this way, each light source 36 emits only light of one wavelength range at one time/for one individual image.

In another embodiment for dividing the light sources 36 into groups, as is shown in FIG. 3f, the light sources 36 are divided into four groups 50a, 50b, 50c, 50d per wavelength range. In the first wavelength range, the groups are denoted with “1,” “2,” “3,” “4” and in the second wavelength range with “a,” “b,” “c,” “d.” The first individual image is recorded with an illumination at which the light sources 36 which are denoted with “1” and “a” are switched on, the second individual image with the light sources 36 with “2” and “b,” a third individual image with light sources 36 with “3” and “c,” and a fourth individual image, in which the light sources 36 which are denoted with “4” and “d” are switched on. Consequently situated between two switched-on light sources 36 is always a row of light sources 36 which are not switched on. In this way, crosstalk during the detection between the individual wavelength ranges can be avoided.

A further embodiment for the division of the light sources 36 into groups is shown in FIG. 3g. Here, only some of the light sources 36 are divided into groups. This is done as follows, for example: first, a preliminary image of the object 18 is recorded, in which all light sources 36 are switched on. Then, in the preliminary image, a region of interest is determined, in which for example structures to be imaged are present in the object 18. Subsequently, the light sources 36 that correspond for the illumination of the section of the object 18 that corresponds in the region of interest are selected. These light sources 36 are then divided into groups as explained above, for example.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A microscope for imaging an object in an object field, comprising
an illumination device for wide-field illumination of the object, wherein the illumination device has a plurality of light sources,
a detection device for recording a wide-field image of the object, and
a control device for controlling the detection device and the illumination device,
wherein the control device divides the light sources into at least two groups, wherein the light sources of all groups together fill the object field without gaps,
wherein the control device for each group switches on all light sources of said group, prompts the detection device to record an individual image of the object, switches off the light sources of said group, and in this way switches through all groups and produces a plurality of individual images, and
wherein the control device produces an image of the object from the individual images produced.

2. The microscope as claimed in claim 1, wherein the light sources of at least one of the groups in the object field directly adjoin one another.

3. The microscope as claimed in claim 1, wherein gaps exist in the object field between the light sources of at least one of the groups.

4. The microscope as claimed in claim 1, wherein the light sources of a first group in the object field are directly adjacent to one another and the light sources of a second group form a subset of the light sources of the first group.

5. The microscope as claimed in claim 1, wherein each of the light sources is configured to produce radiation with at least two different wavelength ranges,
wherein the control device actuates the light sources to emit radiation with different wavelength ranges, and
wherein the control device provides a set of groups for each wavelength range, wherein the light sources of one set fill the object field without gaps and the sets of groups differ.

6. The microscope as claimed in claim 1, wherein the light sources of all groups together are the total number of the light sources.

7. The microscope as claimed in claim 1, wherein the light sources of all groups are part of all light sources of the illumination device.

8. The microscope as claimed in claim 1, wherein the light sources are arranged in columns, wherein the light sources are able to be switched on and off only in columns.

9. A microscopy method for imaging an object in an object field, comprising the steps of:
a) illuminating the object in wide field using an illumination device having a plurality of light sources,
b) dividing the light sources into at least two groups, wherein the light sources of all groups together fill the object field without gaps,
c) switching on all light sources of a group, producing an individual image of the object for this group in wide field, and switching off the light sources of this group,
d) repeating step c) for each group, and
e) producing an image of the object field from the individual images.

10. The microscopy method as claimed in claim 9, wherein the light sources of at least one of the groups illuminate the object field in the form of a grid or at least one stripe.

11. The microscopy method as claimed in claim 9, wherein the light sources of at least one of the groups illuminate the object field quasi-stochastically.

12. The microscopy method as claimed in claim 9, wherein the light sources of a first group are selected such that the light sources thereof homogeneously illuminate the object and in that the light sources of a second group are selected quasi-stochastically from the light sources of the first group.

13. The microscopy method as claimed in claim 9, wherein radiation with at least two different wavelength ranges is produced per light source, wherein a set of groups is provided for each wavelength range, wherein the light sources of a set fill the object field without gaps and the sets of groups differ.

14. The microscopy method as claimed in claim 9, wherein the light sources of all groups correspond to the total number of the light sources.

15. The microscopy method as claimed in claim 9, wherein, first, a preliminary image is recorded in which all light sources are switched on, and subsequently the light sources are divided into groups such that the light sources of all groups illuminate only a partial region of the object.
